(19) United States
(12) Patent Application Publication
(10) Pub. No.: US 2026/0342671 A1
(43) Pub. Date: Oct. 29, 2026

(54) PROACTIVE KPI MANAGEMENT FOR AN INTENT HANDLING FUNCTION

(71) Applicant: Telefonaktiebolaget LM Ericsson (publ), Stockholm (SE)

(72) Inventors: Mirko D'ANGELO, Göteborg (SE); Danesh DAROUI, Gothenburg (SE); András ZAHEMSZKY, SOLLENTUNA (SE); Ahmet Cihat BAKTIR, Istanbul (TR)

(73) Assignee: Telefonaktiebolaget LM Ericsson (publ), Stockholm (SE)

(21) Appl. No.: 19/485,888

(22) PCT Filed: May 24, 2023
(86) PCT No.: PCT/EP2023/063915

§ 371 Date: Nov. 19, 2025

(51) Int. Cl. H04L 41/147; H04L 41/142; H04L 41/16

(52) U.S. Cl. CPC H04L 41/147; H04L 41/142; H04L 41/16

(57) ABSTRACT

A computer-implemented method performed by one or more nodes in a communications network for proactively managing one or more active key performance indicators, KPIs, in a system in the communications network is provided. The method comprises monitoring the one or more active KPIs in the system. The method further comprises retrieving analytics for the one or more active KPIs monitored. The method further comprises processing the retrieved analytics to generate an expected state of the system. The method further comprises providing the generated expected system state for determining predicted KPI values in the expected system state for the one or more active KPIs.

### TECHNICAL FIELD

This disclosure relates to methods, apparatus, and/or systems for proactively managing key performance indicators, KPIs, in a system in the communications network.

### BACKGROUND

In communications networks, intents are used to specify target operating conditions in the communications network. An intent may be described as the formal specification of expectations including requirements, goals, and constraints given to a technical system. Intents may be expressed in human-readable form. Example expectations that may be specified in an intent are: “At least 95% of the ultra-reliable low latency communications URLLC users shall experience a latency of maximum 20 msec”; “At least 80% of the users of the conversational video service shall have a minimum QoE (Quality of Experience) of 4.0”; or “Energy consumption of the system shall be kept to a minimum”. More detailed information on intents and how they relate to closed loops is described in the article “Intent-driven Closed Loops for Autonomous Networks” by Gomez et al. (2021) in the Journal of ICT Standardization, 2021: Vol9 Iss2; ISSN: 2246-0853 (Online Version).

An intent manager or intent handling function, provides a zero-touch control for an environment. The intent manager 100 illustrated in FIG. 1, is configured to act in accordance with (e.g. to implement) one or more intents received from an operator 102, and controls one or more environments 104. An environment is controlled by observing the environment (e.g. through sensors), reasoning 106 around the combination of the perceived situation and prior knowledge 108, and subsequently taking actions on the environment. Note that these steps together form a closed loop. The overall purpose of the intent manager is to perform actions to fulfill the intent(s). FIG. 1 is based on the paper by: Stuart J. Russel, Peter Norvig 2003: “Artificial Intelligence, A Modern Approach” (2013).

FIG. 2 shows an example internal architecture of an Intent manager. The intent manager described on a high level in FIG. 1 can be implemented in a cognitive framework (e.g. cognitive layer). The cognitive framework is further described in the article entitled: “Cognitive processes for adaptive intent-based networking” by Jörg Niemöller et al. Ericsson Technology Review; Nov. 11, 2020. FIG. 2 outlines an implementation in a cognitive framework. One or more intents are sent to the intent manager 100, e.g. by an operator 102. Each expectation in an intent becomes a Key Performance Indicator (KPI) that needs to be met. These are known as KPI targets. Raw data is exposed from the environment 104 and processed by data grounding agents 110. Data grounding agents can collect raw data that describes the state of the managed environment. This raw data is processed and stored in the knowledge base of the intent handler as properties. These properties are used to calculate the values of the measured KPIs. Target and measured KPIs can be compared, and the difference becomes an “issue” or goal that the intent manager needs to meet. For example, if the target KPI is “max 20 ms latency” but the measured KPI is “30 ms latency”, then the issue is to reduce the latency by at least 10 ms. One or more proposal agents 112 are responsible for proposing actions to solve the issues. Evaluation agents 114 make an assessment of which of the proposed actions are most likely to be successful and which should therefore be performed. Actuator agents 116 then execute the selected action on the environment 104 under control.

In the context of a communications network, the environment 104 under control is the communications network itself, or a system therein, and the operator 102 may be a (human) network operator, or other intent handling function. Note that, for scalability reasons, a communications network is typically divided into multiple domains (e.g, there may be more than one environment). Furthermore, intent managers may come in a hierarchy, thus the environment under control could be a part of the mobile network or could be another intent manager. The operator could be (a portal to) the human network operator, or another intent manager.

A more detailed description of intents and the architecture around intents can be found in TM Forum specifications such as “TM Forum Introductory Guide: Autonomous Networks-Technical Architecture” (IG1230) and “TM Forum Introductory Guide: Intent in Autonomous Networks” (IG1253). These specifications also describe intent managers and the envisioned hierarchy of intent managers.

FIG. 3 shows the general architecture 300 of intent-based closed-loop management in a communications network. The general architecture 300 includes measurement agents 302, assurance agents, 304, proposal agents 306, evaluation agents 308, and actuation agents 310. In the general architecture 300 of intent-based closed-loop management, proposal agents 306 are triggered only in the presence of issues. Closed loops try to reconfigure the network with the aim of satisfying requirements specified via intents.

### SUMMARY

In the prior art intent-based closed-loop management, as shown in FIG. 3, the intent manager (IM) waits for a KPI issue to occur before taking corrective actions, and, thus, it might be too late, or very costly to fix and/or address the KPI issue. Embodiments of this disclosure provide for proactively managing KPIs to keep a KPI in line with the specified requirement without waiting for a KPI issue or violation.

Embodiments of this disclosure provide a novel component that receives analytics of interest for active KPIs. The analytics are filtered and aggregated to generate an expected future system state in the form of expected changes to network properties. Prediction agents calculate the impact on all the network properties. Predicted properties are then used by the IM to calculate the impact on active KPIs and create expected issues. This process enables the IM to leverage analytic predictions and to handle intent satisfaction in a proactive way. If a KPI violation is expected to happen, action proposals may be triggered in advance to solve the problem that is expected to come.

Accordingly, in one aspect there is provided a computer-implemented method performed by one or more nodes in a communications network for proactively managing one or more active key performance indicators, KPIs, in a system in the communications network. The method includes monitoring the one or more active KPIs in the system. The method includes retrieving analytics for the one or more active KPIs monitored. The method includes processing the retrieved analytics to generate an expected state of the system. The method includes providing the generated expected system state for determining predicted KPI values in the expected system state for the one or more active KPIs.

In some embodiments, processing the retrieved analytics to generate an expected state of the system includes, if a list of predicted time slots is included in the retrieved analytics, calculating an analytic prediction time as an average of the predicted time slots, and using the calculated analytic prediction time to make uniform the timing aspects of the retrieved analytics.

In some embodiments, processing the retrieved analytics to generate an expected state of the system includes filtering the analytics by identifying each of the analytics with a confidence level equal to or greater than a pre-determined threshold confidence level, and creating a set of the identified analytics by discarding each of the analytics with a confidence level less than the pre-determined threshold confidence level.

In some embodiments, processing the retrieved analytics to generate an expected state of the system includes clustering the set of analytics by grouping the analytics based on an expected prediction time and a confidence level.

In some embodiments, clustering the set of analytics includes representing the set of analytics as datapoints, wherein each datapoint is based on an expected prediction time and a confidence level, and determining a number of clusters of the datapoints representing the set of analytics to minimize the expected variance between the datapoints of each cluster.

In some embodiments, determining the number of clusters of the datapoints representing the set of analytics includes using a decision method based on the Elbow technique.

In some embodiments, processing the retrieved analytics to generate an expected state of the system includes generating an expected state for each cluster, and aggregating the expected state for each cluster into the expected system state.

In some embodiments, generating an expected state for each cluster includes calculating an expected time of the expected state for each cluster, calculating an expected confidence level of the expected state for each cluster, and identifying a centroid for each cluster.

In some embodiments, generating an expected state for each cluster includes one or more of: discarding information repeated in the analytics in the same cluster, aggregating information for the same KPI in the analytics in the same cluster, and/or resolving conflicting information for the same KPI in the analytics in the same cluster by one of: keeping the information for the KPI with the highest confidence level and discarding the other conflicting information, or calculating the information for the KPI as the average of the conflicting information.

In some embodiments, aggregating the expected state for each cluster into the expected system state includes using the centroid identified for each cluster to aggregate the expected state for each cluster into the expected system state.

In some embodiments, monitoring the one or more active KPIs in the system includes receiving information stored in a knowledge base, wherein the received information includes one or more of: measurable properties for the one or more active KPIs, KPI targets for the one or more active KPIs, measured KPIs for the one or more active KPIs, and/or network state.

In some embodiments, the one or more active KPIs monitored are associated with one or more expectations, and the one or more expectations are associated with one or more intents for the system.

In some embodiments, at least one of the one or more nodes in the communication network is an intent manager.

In some embodiments, retrieving analytics for the one or more active KPIs monitored includes requesting the analytics to be retrieved based on rules mapping the one or more active KPIs monitored to a list of relevant analytics, and receiving the requested analytics.

In some embodiments, retrieving analytics for the one or more active KPIs monitored includes requesting the analytics to be retrieved based on using unsupervised learning to identify the relevant analytics for the one or more active KPIs monitored, and receiving the requested analytics.

In some embodiments, the unsupervised learning includes one or more of the following techniques: Markov chain and/or causal graphs.

In some embodiments, the analytics retrieved includes one or more analytics reports.

In some embodiments, retrieving analytics for the one or more active KPIs monitored includes requesting the analytics to be retrieved as an average over a specified time interval, and receiving the requested analytics.

In some embodiments, retrieving analytics for the one or more active KPIs monitored includes requesting the analytics to be retrieved over a specified time interval, receiving the requested analytics, and aggregating the received analytics.

In another aspect, there is provided one or more nodes in a communications network for proactively managing one or more active key performance indicators, KPIs, in a system in the communications network. The one or more nodes include one or more memories comprising instruction data representing a set of instructions, and one or more processors configured to communicate with the one or more memories and to execute the set of instructions.

The set of instructions, when executed by the processor, cause the processor to monitor the one or more active KPIs in the system, retrieve analytics for the one or more active KPIs monitored, process the retrieved analytics to generate an expected state of the system, and provide the generated expected system state for determining predicted KPI values in the expected system state for the one or more active KPIs.

In another aspect, there is provided a computer program comprising instructions which, when executed by processing circuitry, cause the processing circuitry to perform the method of any one of embodiments described above.

In another aspect, there is provided a carrier containing a computer program comprising instructions which, when executed by processing circuitry, cause the processing circuitry to perform the method of any one of embodiments described above, wherein the carrier comprises one of an electronic signal, optical signal, radio signal or computer readable storage medium.

In another aspect, there is provided a computer program product comprising a non-transitory computer readable medium having stored thereon a computer program comprising instructions which, when executed by processing circuitry, cause the processing circuitry to perform the method of any one of embodiments described above.

In another aspect, there is provided an apparatus comprising a memory and processing circuitry coupled to the memory, wherein the apparatus is configured to perform the method of any one of embodiments described above.

Embodiments of this disclosure enable the prevention of a KPI breach using proactive management, which provides at least the following advantages: reduced costs for KPI or upper-level SLA violations, improved performance of the intent manager in terms of resolution time for a KPI requirement, and potential improvement in energy consumption when corrective actions are very energy costly.

### BRIEF DESCRIPTION OF THE DRAWINGS

The accompanying drawings, which are incorporated herein and form part of the specification, illustrate various embodiments.

FIG. 1 shows a zero-touch intent handling mechanism in a communications network (Prior Art).

FIG. 2 shows an intent handling function (e.g. Intent manager) in a communications network (Prior Art).

FIG. 3 shows a general architecture of intent-based closed loop management in a communications network (Prior Art).

FIG. 4 shows an example environment in a communications network.

FIG. 5 shows an example environment in a communications network.

FIG. 6 shows a process according to some embodiments.

FIG. 7 shows an example Markov chain approach graph according to some embodiments.

FIG. 8 shows an example of analytics visualized as datapoints in a graph according to some embodiments.

FIG. 9 shows an example of a decision method for deciding the number of clusters based on the Elbow technique in a graph according to some embodiments.

FIG. 10 shows an example of centroids of analytics clusters in a graph according to some embodiments.

FIG. 11 shows a message flow diagram according to some embodiments.

FIG. 12 shows an example of timing for requesting and receiving analytics in a graph according to some embodiments.

FIG. 13 shows a node in a communications network according to some embodiments.

FIG. 14 shows an apparatus according to some embodiments.

FIG. 15 shows an apparatus according to some embodiments.

### DETAILED DESCRIPTION

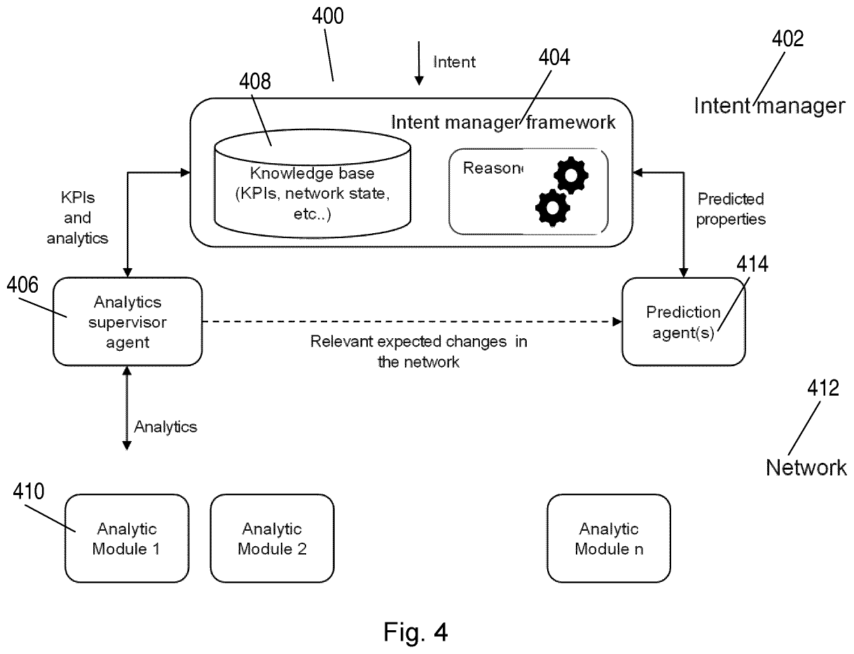

FIG. 4 shows an example environment in a communications network according to embodiments disclosed herein. In FIG. 4, a high-level architecture 400 is illustrated for implementing the proactive KPI management methods disclosed herein. The architecture 400 includes an Intent Manager (IM) 402, and Intent Manager Framework (IMF) 404, an analytics supervisor agent 406, a knowledge base 408, one or more analytics modules 410, network 412, and one or more prediction agent(s) 414. The analytics supervisor agent 406 is provided in the IM 402. The functions performed by the analytics supervisor agent 406 may include:
a. monitoring the active KPIs in the system stored in the knowledge base;
b. subscribing/retrieving analytics of interest for the active KPIs monitored, which may come from different analytic modules 410 that the network 412 exposes (e.g., NWDAF) or from analytics generated by the intent manager framework (IMF); and
c. using the analytics retrieved, and generating one or multiple expected relevant states that the network might be in the future.

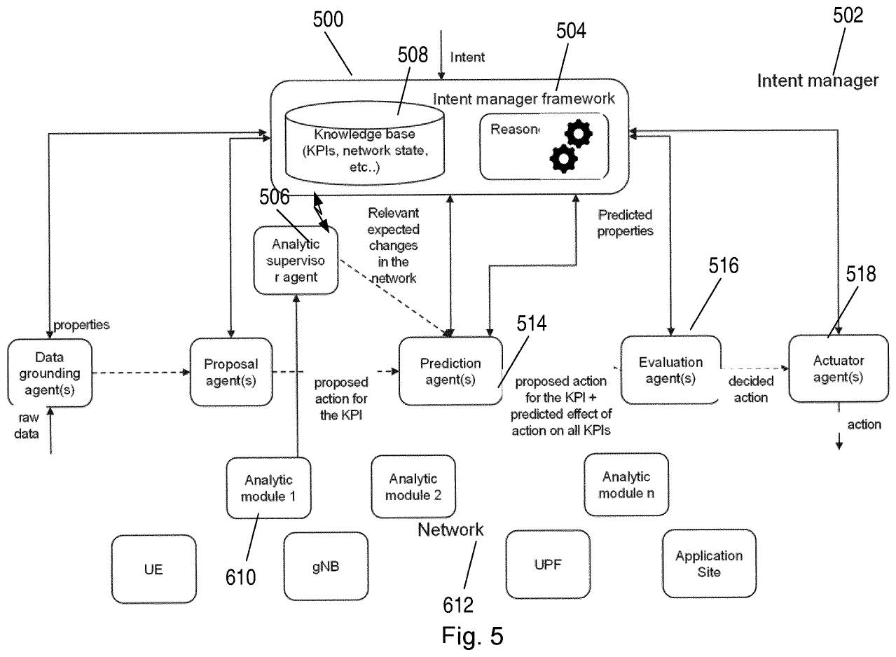

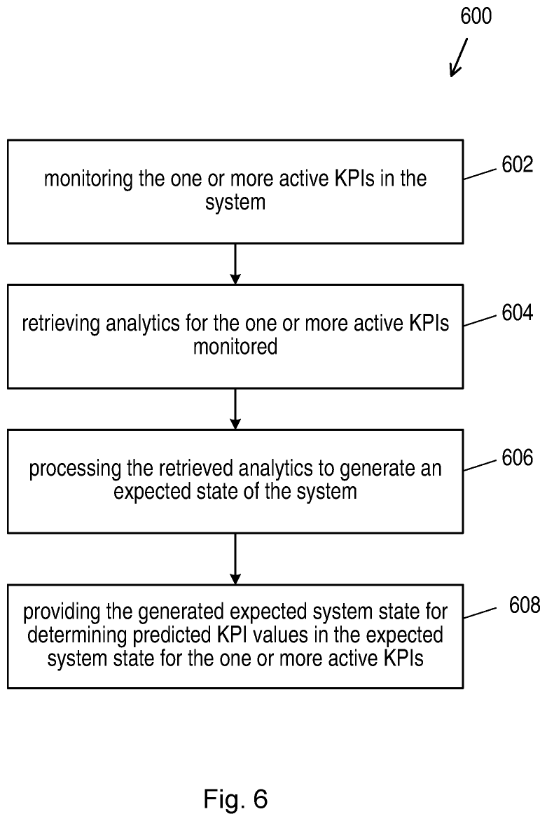

FIG. 5 shows an example environment in a communications network according to embodiments disclosed herein. In FIG. 5, the IM 402 shown as part of the high-level architecture 400 for implementing the proactive KPI management illustrated in FIG. 4, is extended with the proactive KPI handling architecture 500. FIG. 5 shows the Proactive KPI handling architecture in the whole scope of an IMF. The proactive KPI handling architecture 500 illustrated in FIG. 5 includes, in addition to the agents shown in FIG. 4, additional agents including one or more evaluation agent(s) 416 and one or more actuator agent(s) 418. Further details regarding the IM and IMF are set forth in in A. C. Baktir et al. “Intent-based cognitive closed-loop management with built-in conflict handling,” 2022 IEEE 8th International Conference on Network Softwarization (NetSoft)|978-1-6654-0694-9/22/$31.00 @2022 IEEE|DOI: 10.1109/NetSoft54395.2022.9844074. The functions and operation of the various entities and components of the IM 402, IMF 404, network 412 and agents, and the flow of data between them, will be discussed further below with reference to FIGS. 6-15.

FIG. 6 shows a process 600 performed by one or more nodes in a communications network for proactively managing one or more active key performance indicators, KPIs, in a system in the communications network. Process 600 may begin with step s602. Step s602 comprises monitoring the one or more active KPIs in the system. Step s604 comprises retrieving analytics for the one or more active KPIs monitored. Step s606 comprises processing the retrieved analytics to generate an expected state of the system. Step s608 comprises providing the generated expected system state for determining predicted KPI values in the expected system state for the one or more active KPIs.

In some embodiments, processing the retrieved analytics to generate an expected state of the system includes, if a list of predicted time slots is included in the retrieved analytics, calculating an analytic prediction time as an average of the predicted time slots, and using the calculated analytic prediction time to make uniform the timing aspects of the retrieved analytics.

In some embodiments, processing the retrieved analytics to generate an expected state of the system includes filtering the analytics by identifying each of the analytics with a confidence level equal to or greater than a pre-determined threshold confidence level, and creating a set of the identified analytics by discarding each of the analytics with a confidence level less than the pre-determined threshold confidence level.

In some embodiments, processing the retrieved analytics to generate an expected state of the system includes clustering the set of analytics by grouping the analytics based on an expected prediction time and a confidence level.

In some embodiments, clustering the set of analytics includes representing the set of analytics as datapoints, wherein each datapoint is based on an expected prediction time and a confidence level, and determining a number of clusters of the datapoints representing the set of analytics to minimize the expected variance between the datapoints of each cluster.

In some embodiments, determining the number of clusters of the datapoints representing the set of analytics includes using a decision method based on the Elbow technique.

In some embodiments, processing the retrieved analytics to generate an expected state of the system includes generating an expected state for each cluster, and aggregating the expected state for each cluster into the expected system state.

In some embodiments, generating an expected state for each cluster includes calculating an expected time of the expected state for each cluster, calculating an expected confidence level of the expected state for each cluster, and identifying a centroid for each cluster.

In some embodiments, generating an expected state for each cluster includes one or more of: discarding information repeated in the analytics in the same cluster, aggregating information for the same KPI in the analytics in the same cluster, and/or resolving conflicting information for the same KPI in the analytics in the same cluster by one of: keeping the information for the KPI with the highest confidence level and discarding the other conflicting information, or calculating the information for the KPI as the average of the conflicting information.

In some embodiments, aggregating the expected state for each cluster into the expected system state includes using the centroid identified for each cluster to aggregate the expected state for each cluster into the expected system state.

In some embodiments, monitoring the one or more active KPIs in the system includes receiving information stored in a knowledge base, wherein the received information includes one or more of: measurable properties for the one or more active KPIs, KPI targets for the one or more active KPIs, measured KPIs for the one or more active KPIs, and/or network state.

In some embodiments, the one or more active KPIs monitored are associated with one or more expectations, and the one or more expectations are associated with one or more intents for the system.

In some embodiments, at least one of the one or more nodes in the communication network is an intent manager.

In some embodiments, retrieving analytics for the one or more active KPIs monitored includes requesting the analytics to be retrieved based on rules mapping the one or more active KPIs monitored to a list of relevant analytics, and receiving the requested analytics.

In some embodiments, retrieving analytics for the one or more active KPIs monitored includes requesting the analytics to be retrieved based on using unsupervised learning to identify the relevant analytics for the one or more active KPIs monitored, and receiving the requested analytics.

In some embodiments, the unsupervised learning includes one or more of the following techniques: Markov chain and/or causal graphs.

In some embodiments, the analytics retrieved includes one or more analytics reports.

In some embodiments, retrieving analytics for the one or more active KPIs monitored includes requesting the analytics to be retrieved as an average over a specified time interval, and receiving the requested analytics.

In some embodiments, retrieving analytics for the one or more active KPIs monitored includes requesting the analytics to be retrieved over a specified time interval, receiving the requested analytics, and aggregating the received analytics.

### KPI Monitoring and Analytics Subscription

The analytics supervisor agent 406 monitors active KPIs (e.g., latency of a group of URLLC users equal to 50 ms, with UE_1, UE_2, and UE_3 part of the group) and subscribes to mobility prediction for the group of users. There are different ways of identifying relevant analytics for a given KPI, for example:
a. Domain knowledge is used to map the KPI to analytics (e.g., mobility analytic prediction)
b. Alternatively, the relation between monitored KPI and needed analytics is learned offline or online (e.g., ML, Markov chain approach, causal graphs)

In option “a” the IM is provided with rules mapping a given KPI with a list of relevant analytics. Option “b” can be realized by using, for example, a Markov Chain approach where the links between KPIs and Analytics can be learned from data.

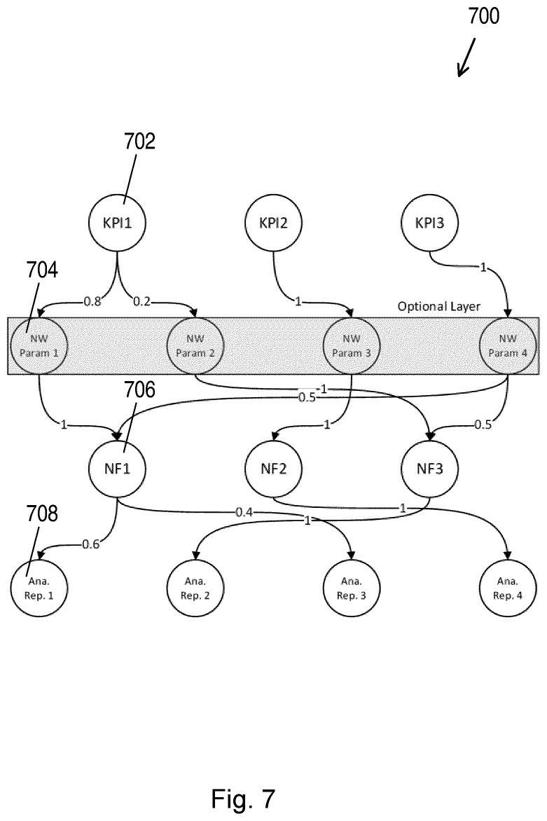

FIG. 7 shows an example Markov chain approach graph 700 mapping KPIs to analytics, according to some embodiments. FIG. 7 shows an example of how such a technique can be implemented. The Markov Chain is created initially by the analytics supervisor agent 406 with the probability values on each edge assigned using the extra information about the network i.e., how KPIs 702 are correlated to network parameters, NFs, 706 and, finally, analytics reports 708. In this example, a layer for the network parameters 704 is optional, meaning that the KPIs can be directly correlated to NFs 706 and then the analytics reports 708 that are relevant for specific NF(s). More layers can be added to the model which is shown in FIG. 7 to increase the granularity when the graph 700 is being traversed. Other layers can, for example, be domain or group of analytics reports e.g., UE-related, performance related.

The approach illustrated in FIG. 7 can learn, for example, that for KPI1, the relevant analytics are Ana. Rep. 1, 2 and 3. In this case, Ana Rep. 4 is left out because it is not directly correlated with the KPI via network-related aspects (see intermediary layers of FIG. 7).

Example of Analytics from 5GC:

Examples of analytics predictions, with reference to TS 23.288, include the following analytics examples:

### Observed Service Experience Prediction:

| | |
|---|---|
| Confidence | Confidence of this prediction |
| Application service | List of predicted service experience information |
| experiences | for each Application. |
| (0 . . . max) | |
| S-NSSAI | Identifies the Network Slice used to access the |
| | Application. |
| Application ID | Identification of the Application. |
| Service | Type of Service Experience analytics, e.g. on |
| Experience Type | voice, video, other. |
| UE location | Indicating the UE location information (e.g. TAI |
| | list, gNB ID, etc) when the UE service is delivered. |
| Validity period | Validity period for the Application service |
| | experience analytics |

Reporting an observed service experience for an application (e.g., URLLC application) from which, for example, QoE can be calculated.

### UE Mobility Prediction:

| | |
|---|---|
| UE group ID or UE ID | Identifies a UE or a group of UEs |
| Time slot entry | List of predicted time slots |
| Time slot start | Time slot start time within the Analytics |
| | target period |
| Duration | Duration of the time slot |
| UE location | Predicted location prediction during the |
| | Analytics target period |
| UE location | TA or cells where the UE or UE group may |
| | move into |
| Confidence | Confidence of this prediction |
| Ratio | Percentage of UEs in the group (in the |
| | case of a UE group) |

Reporting UE or group of UE predicted location (e.g., TA or cells) where UE(s) might move into.

### User Data Congestion Prediction:

| | |
|---|---|
| Area of Interest | A list of TAIs or Cell IDs. |
| List of user data | List of user data congestion Analytics. |
| congestion Analytics | |
| (1 . . . max) | |
| Type | User Plane or Control Plane. |
| Applicable Time Window | The time period that the analytics |
| | applies to. |
| Network Status Indication | Congestion Level. |
| Confidence | Confidence of this prediction. |
| List of top applications | The list of applications predicted |
| in UL (0 . . . N_{U}) | to contribute most of the traffic |
| | in the UL direction. |
| Application ID | Application identifier |
| IP Packet Filter Set | IP Packet Filter set |
| Percentage | The application's throughput as |
| | a percentage of the total |
| | throughput in the Area of Interest. |
| Confidence | Confidence of this prediction. |
| List of top applications | The list of applications predicted |
| in DL (0 . . . N_{D}) | to contribute most of the traffic |
| | in the DL direction. |
| Application ID | Application identifier |
| IP Packet Filter Set | IP Packet Filter set as defined in TS |
| | 23.501 [2] clause 5.8.2 (see NOTE 2). |
| Percentage | The application's throughput as |
| | a percentage of the total |
| | throughput in the Area of Interest. |
| Confidence | Confidence of this prediction. |

Predicting the list of top application contributing most to the traffic in an area of interest.

### KPI Example and Intent Relation:

A KPI that can benefit from the analytics mentioned in the Example of analytics from 5GC described above can be expressed as an expectation in an intent-based system. For example, a latency expectation of a URLLC application:

ex:urllc-expectation
a ex:ThresholdedMetricLessThanExpectation ;
ex:target ne:urllc_usrg_group_instance;
ex:hasContext ne:urllc-service-instance;
ex:percent 0.99 ;
ex:params [
ex:latency 150;
] .

Requiring that the latency for 99% of the users being part of the “urllc_usrg_group_instance” must be at max 150 ms.

### Filtering, Clustering, and State Aggregation

The role of the analytics supervisor agent 406 is not to be a simple proxy for analytic subscriptions. The analytics supervisor agent 406 processes the set of analytics received and provides one coherent expected state to the one or more prediction agents 414, as shown in FIG. 5. An expected state is generated from the received analytics. Since the analytic supervisor agent 406 can receive multiple analytics over time, the methods disclosed herein provide for taking into consideration only the relevant analytics, discarding the ones that are not relevant. States of the relevant analytics are grouped and aggregated to define a coherent future, expected state.

In some embodiments, the process of defining a future, expected state includes: pre-processing and filtering, clustering, and state aggregation.

### Pre-Processing and Filtering

Once analytics are received, the prediction time of the analytics is optionally pre-processed by the analytics supervisor agent 406. This is necessary in some cases, for example in 3GPP TS 23.288, because a general timing solution for all types of analytics reports was not devised. In this case, the analytics supervisor agent 406 works in a way to uniform timing aspects of different analytic reports.

For example, the analytic prediction time is calculated as the average of the prediction slot if a time slot is provided in the analytic prediction report (for example, a 5GC analytics report). Another example is when prediction time is not provided at all, e.g., TS 23.288 abnormal behavior analytics. In this case, the analytics supervisor agent 406 could use the time the analytics is requested as analytic time.

The analytics supervisor agent 406 filters the analytics by keeping only the ones with confidence level higher than a certain specified confidence threshold C_min, with C_min coming, for example, as a design time parameter (e.g., C_min=70%). This means that analytics with confidence level lower than the specified confidence threshold will be discarded. This allows generating expected future issues with a certain “risk level” specified at design time. The analytics supervisor agent 406 may also discard the analytics that do not respect the reported confidence level (e.g., realization of the latter aspect out of the scope).

### Clustering

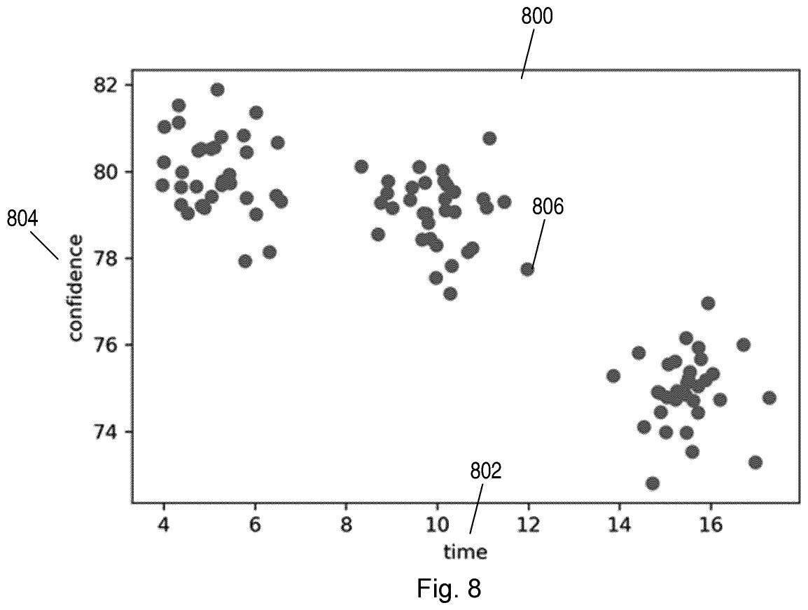

Using clustering, the analytics supervisor agent 406 groups the analytics by expected prediction time and confidence level. After filtering all the analytics with less than e.g., 70% confidence, the analytics supervisor agent 406, at a certain point in time, is presented with the a set of analytics, represented as datapoints in FIG. 8.

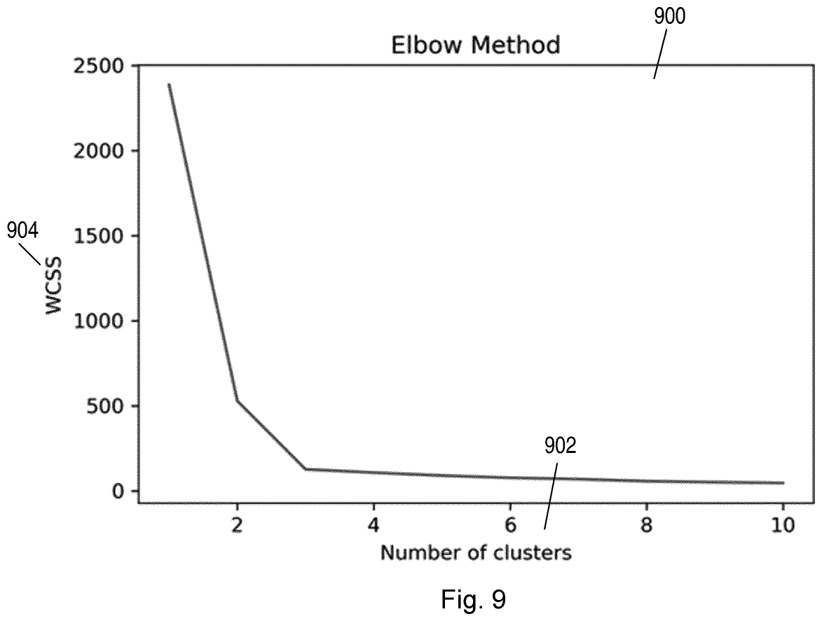

FIG. 8 shows an example of analytics visualized as datapoints in a graph 800 according to some embodiments. The analytics are visualized as datapoints 806 in the graph by prediction time (x-axis) 802 and confidence level (y-axis) 804. The analytic supervisor agent 406 decides the number of clusters autonomously, for example, by using a decision method based on the Elbow technique, illustrated in FIG. 9, trying to minimize the expected variance between datapoints of each cluster. A suitable procedure for the decision method includes, for example, the elbow point discriminant method, which yields a statistical metric that estimates an optimal cluster number when clustering on a dataset. First, the average degree of distortion obtained by the Elbow method is normalized to the range of 0 to 10. Second, the normalized results are used to calculate the cosine of intersection angles between elbow points. Third, this calculated cosine of intersection angles and the arccosine theorem are used to compute the intersection angles between elbow points. Finally, the index of the above-computed minimal intersection angles between elbow points is used as the estimated potential optimal cluster number. see, e.g., Shi et al. J Wireless Com Network (2021) 2021:31 https://doi.org/10.1186/s13638-021-01910-w.

FIG. 9 shows an example of a decision method for deciding the number of clusters based on the Elbow technique in a graph, according to some embodiments. The x-axis of the graph 900 is the number of clusters 902 and the y-axis is the Within-Cluster Sum of Square (WCSS) 904. In this example, the minimum number of clusters for which the squared distance between data points is “optimal” is 3 (for the example, as illustrated in FIG. 8).

### State Aggregation

For each cluster identified, the analytics supervisor agent 406 generates an expected state in, for example, the following way:
a. eTs is the expected time of the predicted state, identified by the centroid of the cluster (i.e., calculated as an average of the prediction time of the analytics in the cluster); and
b. eCs is the expected confidence level of the predicted state, identified by the centroid of the cluster (i.e., calculated as an average of the confidence level of the analytics in the cluster).

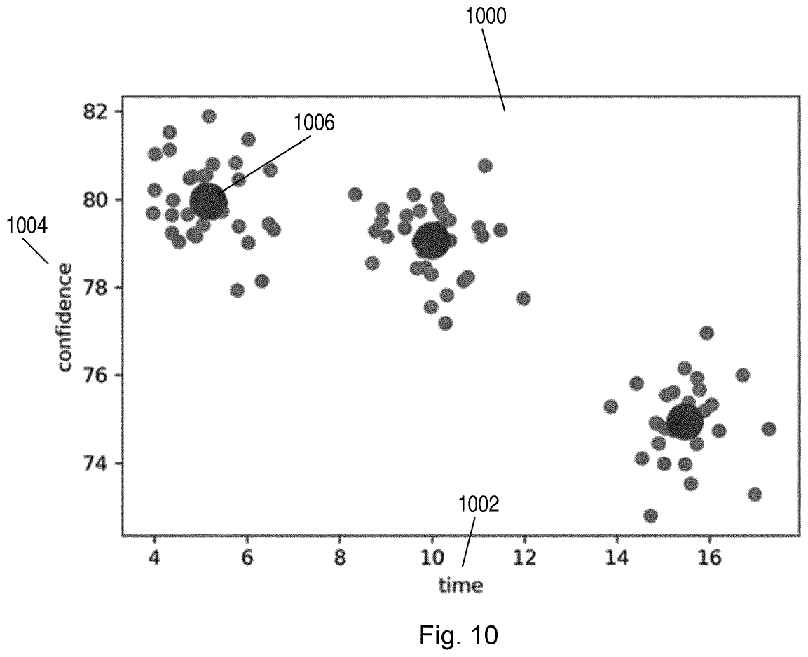

These values are calculated and identified, as shown in FIG. 10, which shows with, larger sized dots, the centroids of the clusters.

FIG. 10 shows an example of centroids of analytics clusters in a graph according to some embodiments. FIG. 10 includes the example of analytics visualized as datapoints in a graph, as shown in FOG. 8, with the analytics being visualized as datapoints 806 in the graph 1000 by prediction time (x-axis) 1002 and confidence level (y-axis) 1004. The larger sized dots 1006 show the centroids of the clusters which are used for state aggregation.

As part of calculating and identifying the centroids of the clusters, for repeating analytics info:
a. Repeating information reported by multiple analytics in the same cluster is discarded e.g., SUPI, information about Tracking Area (TA) and Area of Interest (AoI), etc.

For analytics info for the same metric:
a. When analytics predict different metrics, the states are simply aggregated. For example: <UE1,QoE=1> and <UE1,MBR=5> simply become: <UE1,QOE=1 and MBR=5>

For different analytics info for the same metric:
a. When different info for the same metric is reported (for example because multiple analytics of the same type end in the same cluster) the “conflict” should be resolved, for example, by:
   i. The metric associated with the analytic with the highest confidence is kept, while others are discarded; or
   ii. The info on the metric is calculated as the average of the repeating info.

The predicted state is then formulated as a single entity <eTs, eCs, predicted_system_state> to be sent to the prediction agents 414.

State aggregation can, for example, be implemented as classes in an object-oriented programming language. A base class represents a generic implementation of an analytics report, while each subclass for a specific analytics report inherits methods and properties from the base class and implements the abstract methods accordingly.

The code snippet below is an example of an abstract base class of analytics report. Each type of analytics report (e.g., UE mobility, User data congestion) implements the virtual methods based on its own purpose.

Code snippet: OO implementation of analytics report

```
class analyticsReport {
  public:
    // Perform discovery for an NWDAF instance.
    virtual string discovery(string nrfAddr) = 0;
    // Send request for an analytics report.
    virtual bool sendReq(int anaID,
      string nwdafAddr,
      int period,
      bool pred,
      char& input) = 0;
    // Event handler to be triggered when notification is
    // received.
    virtual void onNotif(chr& anaRep) = 0;
};
```

### Prediction Agents

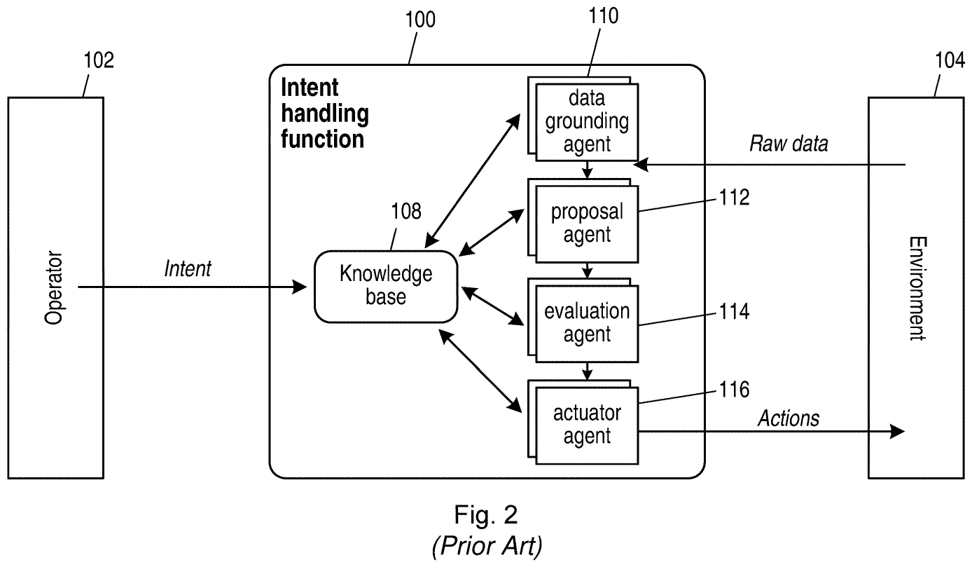

Prediction agents 414 are components already part of the intent-based closed-loop management approach. For example, they are part of the set of evaluation agents in FIG. 2.

Embodiments disclosed herein, implementing the disclosed method for proactively managing KPIs, use prediction agents 414 to predict further effects of a predicted state on the KPIs in the network. The prediction agents 414 receive the expected system state as input and calculate the state's impact on all the system properties. Properties are then used by the IMF 404 to calculate the KPI values associated to the expected system state.

### EXAMPLE

a. Expected system state: <eTs=30s, eCs=97% ,UE_1 and U_2 attached to gNB_1>
b. Predicted properties:
   i. UE_1 latency=100 ms
   ii. UE_2 latency=150 ms
   iii. UE_3 latency=20 ms
   iv. UE_1 throughput= . . .
c. Predicted KPIs for the expected system state:
   i. URLLC group average latency=90 ms (calculated from the predicted properties)

From the above example, we can see that the average latency for the URLLC group is predicted to be 90 ms. The information can be stored in the knowledge base 408 in the following way:
a. In a non-formal way: “In 30s URLLC group latency will be 90 ms with a confidence level 97%, while the average latency is 50 ms (as submitted in the intent)”
b. Generate an expected issue object for the latency KPI of the URLLC group

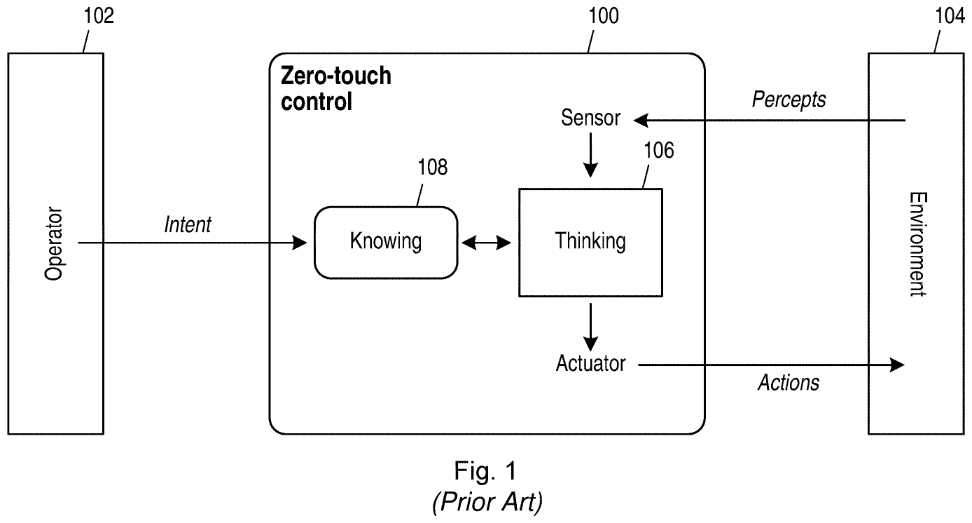

Once an “expected issue” is generated, it is possible to trigger action proposals, following the classical closed-loop approach, as shown in FIG. 1, that, instead of working on a current (or real) issue, works on an issue expected to appear in the future. The loop will work in a proactive way to solve the expected issue.

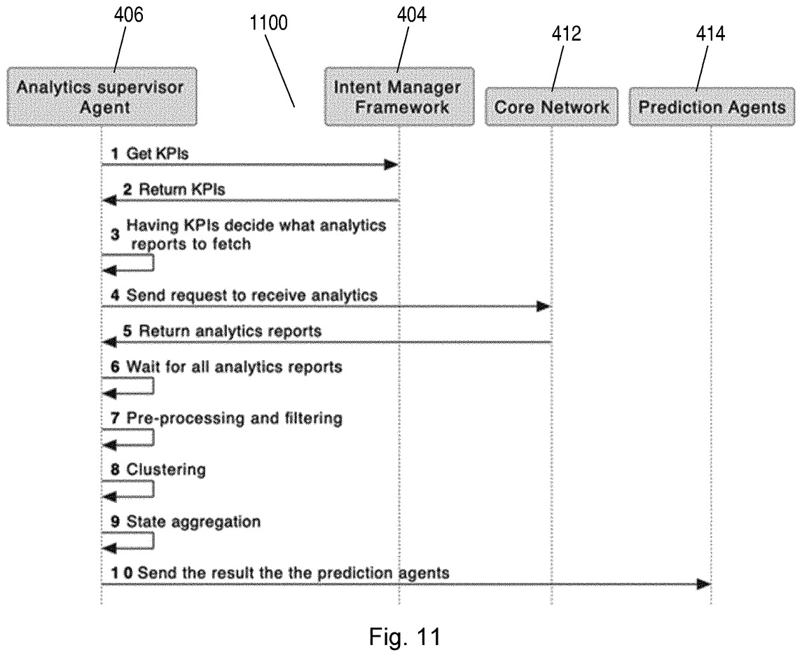

FIG. 11 shows a message flow diagram 1100 according to some embodiments. The message flow diagram 1100 shows the complete flow of monitoring active KPIs, requesting analytics reports, processing the analytics, and sending the results to prediction agents. The message flow for the process (from getting KPIs to sending the results to prediction agents) involves the analytics supervisor agent 406, intent manager framework 404, core network 412, and prediction agents 414.

With reference to FIG. 11, the analytics supervisor agent 406 first gets the active KPIs from the IMF 404 (steps 1 and 2). The process of deciding which analytics to monitor for the active KPIs is performed in step 3. The analytics supervisor agent 406 then triggers the process by sending a request to the core network 412 e.g., NWDAF, to receive predictions about the network state in the future. After requesting the analytics (steps 4 and 5), the analytics supervisor agent 406, optionally, waits (step 6) for receiving all the analytics requested. A timer can be implemented in step 6 to specify a timeout value and avoid blocking situations. The received information will be pre-processed and filtered (step 7), clustered (step 8), and aggregated into, as described above in the example, an expected system state (step 9), and finally sent to prediction agents 414 (step 10).

Note that, in the exemplary message flow shown in FIG. 11, the Core Network 412 is the recipient of subscription in case analytics come from NWDAF (i.e., currently a 5G advanced network function). In general, however, the flow can be realized by subscribing to whatever entity is able to provide analytics information.

### The Trend of KPIs Changes

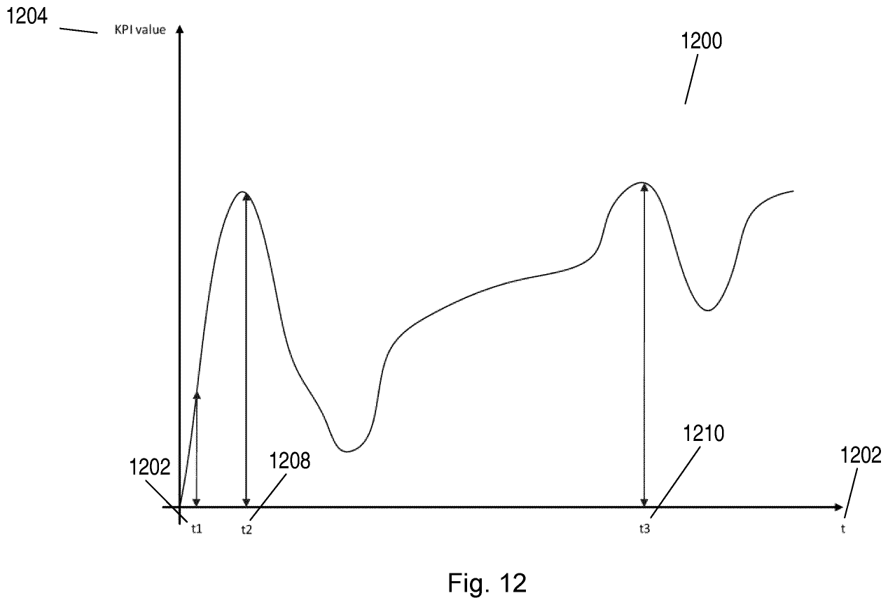

Embodiments disclosed herein are focused on the network state and, hence, KPI values at different times in the future. However, it is likely that the value of the KPIs of interest might change frequently before it is reached at a certain point or stabilized. FIG. 12 shows an example of timing for requesting and receiving analytics in a graph according to some embodiments. The graph 1200 shows t (time) 1202 on the x-axis and KPI value 1204 on the y-axis. The time 1202 illustrated in the graph includes the timing for sending a request for analytics report (t1) 1206, receiving the results (t2) 1208, and the point in time that the prediction has been made (t3) 1210.

With reference to FIG. 12, the request to receive analytics reports is sent to the core network at time t1 1206, and the results of the prediction are received at t2 1208. The received result includes the predicted value of the KPI at time t3 1201, which was indicated in the request sent at t1 1206. Between t2 1208 and t3 1210, the value of the KPI 1204 has been changed drastically at different points in the time, while the trend of the KPI value 1204 is upward. Therefore, we utilize, for the embodiments disclosed herein, the predicted state of the network at t3 1210.

To tackle oscillations of analytics predictions in a simple yet effective way, the analytic supervisor agent 406 may request the analytic module 410, recipient of subscription, to report the analytics prediction as an average over a certain time interval. If such API is not supported by the analytic module 410, the analytic supervisor agent 406 can aggregate the same analytic report over a certain time period before considering it as a data point for the clustering techniques. If the variance for the reported analytics is too high, the analytic supervisor agent 406 can also fully discard the received analytics instead of trying to make sense out of them. All of these optional steps do not affect and are not required by the methods of the exemplary embodiments described above.

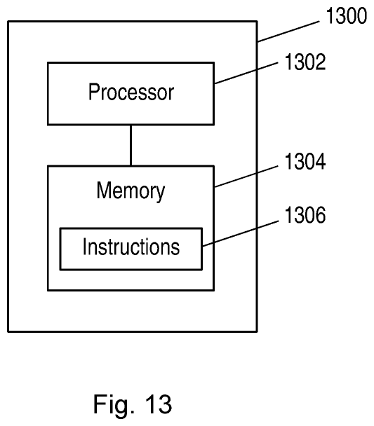

FIG. 13 illustrates a node 1300 in a communications network according to some embodiments. Generally, the node 1300 may comprise any component or network function (e.g. any hardware or software module) in the communications network suitable for performing the functions described herein. For example, a node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC).

The node 1300 may be an Intent Manager, or Intent Handling Function. The node 1300 may be embedded in a cognitive layer of the communications network.

The node 1300 is configured (e.g. adapted, operative, or programmed) to perform any of the embodiments of the method 600 as described herein. It will be appreciated that the node 1300 may comprise one or more virtual machines running different software and/or processes. The node 1300 may therefore comprise one or more servers, switches and/or storage devices and/or may comprise cloud computing infrastructure or infrastructure configured to perform in a distributed manner, that runs the software and/or processes.

The node 1300 may comprise a processor (e.g. processing circuitry or logic) 1302. The processor 1302 may control the operation of the node 1300 in the manner described herein. The processor 1302 can comprise one or more processors, processing units, multi-core processors or modules that are configured or programmed to control the node 1300 in the manner described herein. In particular embodiments, the processor 1302 can comprise a plurality of software and/or hardware modules that are each configured to perform, or are for performing, individual or multiple steps of the functionality of the node 1300 as described herein.

The node 1300 may comprise a memory 1304. In some embodiments, the memory 1304 of the node 1300 can be configured to store program code or instructions 1306 that can be executed by the processor 1302 of the node 1300 to perform the functionality described herein. Alternatively, or in addition, the memory 1304 of the node 1300, can be configured to store any requests, resources, information, data, signals, or similar that are described herein. The processor 1302 of the node 1300 may be configured to control the memory 1304 of the node 1300 to store any requests, resources, information, data, signals, or similar that are described herein.

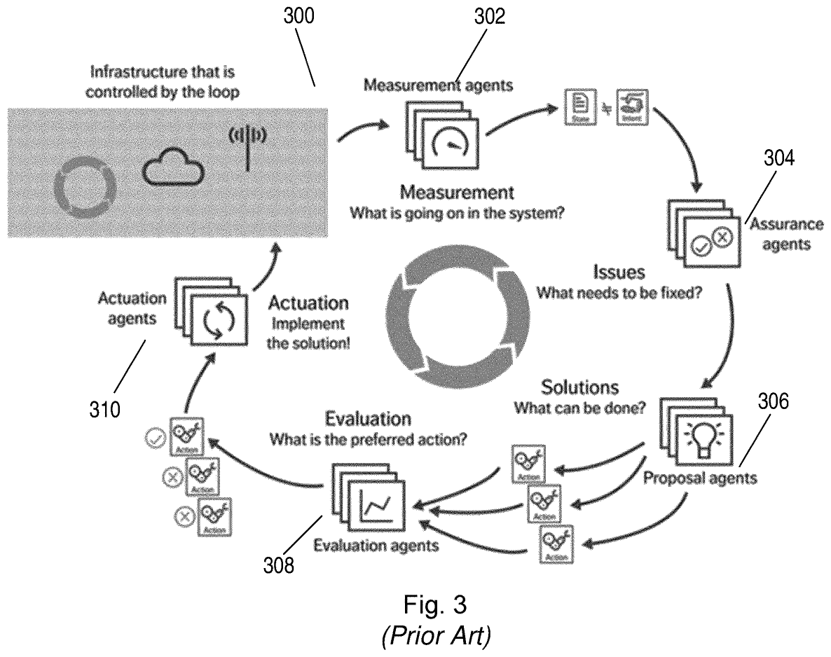

It will be appreciated that the node 1300 may comprise other components in addition or alternatively to those indicated in FIG. 3. For example, in some embodiments, the node 1300 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 1302 of node 1300 may be configured to control such a communications interface to transmit to and/or receive from other nodes or network functions requests, resources, information, data, signals, or similar.

The disclosure herein relates to a communications network (or telecommunications network). A communications network may comprise any one, or any combination of: a wired link (e.g. ADSL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

One or more nodes 1300 in a communications network may be configured for proactively managing one or more active key performance indicators, KPIs, in a system in the communications network. The one or more nodes 1300 include one or more memories 1304 comprising instruction data representing a set of instructions 1306, and one or more processors 1302 configured to communicate with the one or more memories 1304 and to execute the set of instructions 1306. The set of instructions, when executed by the processor, cause the processor to monitor the one or more active KPIs in the system, retrieve analytics for the one or more active KPIs monitored, process the retrieved analytics to generate an expected state of the system, and provide the generated expected system state for determining predicted KPI values in the expected system state for the one or more active KPIs.

The one or more nodes may be configured to perform the method of any one of the embodiments disclosed herein. In some embodiments, the set of instructions 1306, when executed by the one or more processors 1302, further cause the one or more processors 1302 to perform the method of any one of the embodiments disclosed herein.

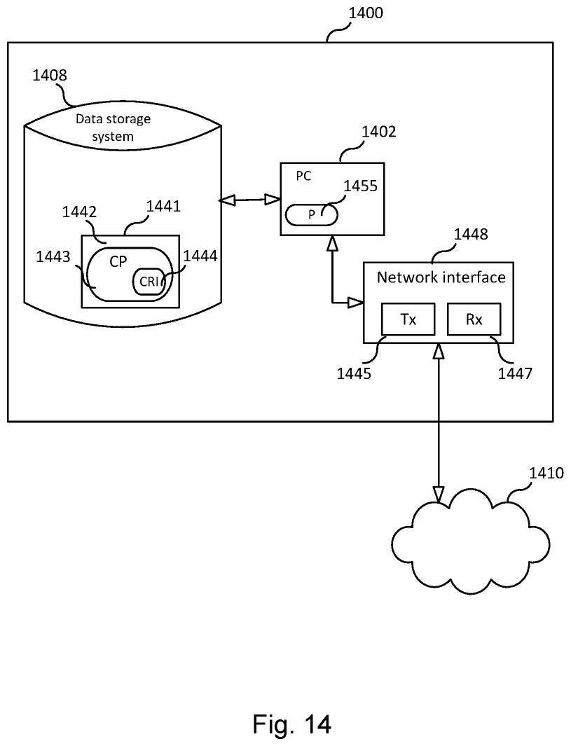

FIG. 14 is a block diagram of an apparatus 1400, according to some embodiments, for implementing any of the entities and/or performing any of the functions shown in FIG. 5. As shown in FIG. 14, apparatus 1400 may comprise: processing circuitry (PC) 1402, which may include one or more processors (P) 1455 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1400 may be a distributed computing apparatus); a network interface 1448 comprising a transmitter (Tx) 1445 and a receiver (Rx) 1447 for enabling apparatus 1400 to transmit data to and receive data from other nodes connected to a network 1410 (e.g., an Internet Protocol (IP) network) to which network interface 1448 is connected (directly or indirectly) (e.g., network interface 1448 may be wirelessly connected to the network 1410, in which case network interface 1448 is connected to an antenna arrangement); and a local storage unit (a.k.a., “data storage system”) 1408, which may include one or more non-volatile storage devices and/or one or more volatile storage devices. In embodiments where PC 1402 includes a programmable processor, a computer program product (CPP) 1441 may be provided. CPP 1441 includes a computer readable medium (CRM) 1442 storing a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes apparatus 1400 to perform steps described herein (e.g., steps described herein with reference to the flow charts). In other embodiments, apparatus 1400 may be configured to perform steps described herein without the need for code. That is, for example, PC 1402 may consist merely of one or more ASICs. Hence, the features of the embodiments described herein may be implemented in hardware and/or software.

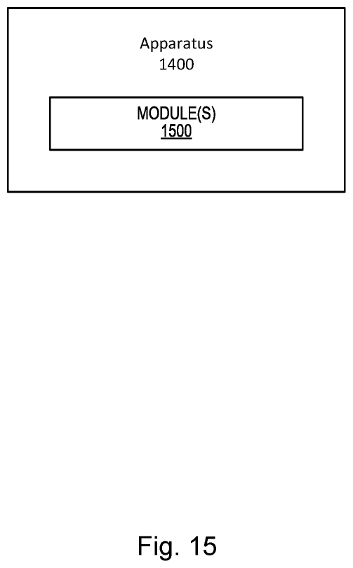

FIG. 15 is a block diagram of the apparatus 1400 according to some embodiments. The apparatus 1400 includes one or more modules 1500, each of which is implemented in software. The module(s) 1500 provide the functionality of apparatus 1400 described herein and, in particular, the functionality of one or more nodes (e.g., the steps herein, e.g., with respect to FIG. 6).

Turning now to other embodiments, there is also provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, as used herein, transmitting a message to a device encompasses transmitting the message directly to the device or transmitting the message indirectly to the device (i.e., one or more nodes are used to relay the message from the source to the device). Likewise, as used herein, receiving a message from a device encompasses receiving the message directly from the device or indirectly from the device (i.e., one or more nodes are used to relay the message from the device to the receiving node).

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer-implemented method performed by one or more nodes in a communications network for proactively managing one or more active key performance indicators (KPIs) in a system in the communications network, the method comprising:
i) monitoring the one or more active KPIs in the system;
ii) retrieving analytics for the one or more active KPIs monitored;
iii) processing the retrieved analytics to generate an expected state of the system; and
iv) providing the generated expected system state for determining predicted KPI values in the expected system state for the one or more active KPIs.

2. The method according to claim 1, wherein processing the retrieved analytics to generate an expected state of the system comprises:
i) if a list of predicted time slots is included in the retrieved analytics, calculating an analytic prediction time as an average of the predicted time slots; and
ii) using the calculated analytic prediction time to make uniform the timing aspects of the retrieved analytics.

3. The method according to claim 1, wherein processing the retrieved analytics to generate an expected state of the system comprises:
i) filtering the analytics by identifying each of the analytics with a confidence level equal to or greater than a pre-determined threshold confidence level; and
ii) creating a set of the identified analytics by discarding each of the analytics with a confidence level less than the pre-determined threshold confidence level.

4. The method according to claim 3, wherein processing the retrieved analytics to generate an expected state of the system comprises:
i) clustering the set of analytics by grouping the analytics based on an expected prediction time and a confidence level.

5. The method according to claim 4, wherein clustering the set of analytics comprises:
i) representing the set of analytics as datapoints, wherein each datapoint is based on an expected prediction time and a confidence level; and
ii) determining a number of clusters of the datapoints representing the set of analytics to minimize the expected variance between the datapoints of each cluster.

6. The method according to claim 5, wherein determining the number of clusters of the datapoints representing the set of analytics includes using a decision method based on the Elbow technique.

7. The method according to claim 4, wherein processing the retrieved analytics to generate an expected state of the system comprises:
i) generating an expected state for each cluster; and
ii) aggregating the expected state for each cluster into the expected system state.

8. The method according to claim 7, wherein generating an expected state for each cluster comprises:
i) calculating an expected time of the expected state for each cluster;
ii) calculating an expected confidence level of the expected state for each cluster; and
iii) identifying a centroid for each cluster.

9. The method according to claim 7, wherein generating an expected state for each cluster comprises one or more of:
i) discarding information repeated in the analytics in the same cluster;
ii) aggregating information for the same KPI in the analytics in the same cluster; and/or
iii) resolving conflicting information for the same KPI in the analytics in the same cluster by one of:
a. keeping the information for the KPI with the highest confidence level and discarding the other conflicting information; or
b. calculating the information for the KPI as the average of the conflicting information.

10. The method according to claim 7, wherein aggregating the expected state for each cluster into the expected system state comprises:
i) using a centroid identified for each cluster to aggregate the expected state for each cluster into the expected system state.

11. The method according to claim 1, wherein monitoring the one or more active KPIs in the system comprises receiving information stored in a knowledge base, wherein the received information includes one or more of:
i) measurable properties for the one or more active KPIs;
ii) KPI targets for the one or more active KPIs;
iii) measured KPIs for the one or more active KPIs; and/or
iv) network state.

12. The method according to claim 1, wherein the one or more active KPIs monitored are associated with one or more expectations, and the one or more expectations are associated with one or more intents for the system.

13. The method according to claim 12, wherein at least one of the one or more nodes in the communication network is an intent manager.

14. The method according to claim 1, wherein retrieving analytics for the one or more active KPIs monitored comprises:
i) requesting the analytics to be retrieved based on rules mapping the one or more active KPIs monitored to a list of relevant analytics; and
ii) receiving the requested analytics.

15. The method according to claim 1, wherein retrieving analytics for the one or more active KPIs monitored comprises:
i) requesting the analytics to be retrieved based on using unsupervised learning to identify the relevant analytics for the one or more active KPIs monitored; and
ii) receiving the requested analytics.

16. The method according to claim 15, wherein the unsupervised learning includes one or more of the following techniques:
i) Markov chain; and/or
ii) causal graphs.

17. (canceled)

18. The method according to claim 1, wherein retrieving analytics for the one or more active KPIs monitored comprises:
i) requesting the analytics to be retrieved as an average over a specified time interval; and
ii) receiving the requested analytics.

19. The method according to claim 1, wherein retrieving analytics for the one or more active KPIs monitored comprises:
i) requesting the analytics to be retrieved over a specified time interval;
ii) receiving the requested analytics; and
iii) aggregating the received analytics.

20. One or more nodes in a communications network for proactively managing one or more active key performance indicators (KPIs) in a system in the communications network, the one or more nodes comprising:
one or more memories comprising instruction data representing a set of instructions; and
one or more processors configured to communicate with the one or more memories and to execute the set of instructions, wherein the set of instructions, when executed by the processor, cause the processor to:
i) monitor the one or more active KPIs in the system;
ii) retrieve analytics for the one or more active KPIs monitored;
iii) process the retrieved analytics to generate an expected state of the system; and
iv) provide the generated expected system state for determining predicted KPI values in the expected system state for the one or more active KPIs.

21.-23. (canceled)

24. A computer program product comprising a non-transitory computer readable medium storing instructions which, when executed by processing circuitry, causes the processing circuitry to carry out a method according to claim 1.

25.-27. (canceled)
